(19) United States
(12) Patent Application Publication
(10) Pub. No.: US 2005/0072223 A1
(43) Pub. Date: Apr. 7, 2005

(54) Device for combined detection of axle acceleration and wheel rotational speed and method for determining pressure

(75) Inventors: Helmut Fennel, Bensheim (DE); Peter Lohberg, Friedrichsdorf (DE); Martin Grieber, Eschborn (DE); Andreas Kobe, Bensheim (DE); Alfons Dorr, Hannover (DE)

Correspondence Address: Robert P Seitter;RatnerPrestia, Suite 301, One Westlakes, P O Box 980, Valley Forge, PA, 19482-0980, US

(73) Assignee: Continental Teves AG & Co. oHG

(21) Appl. No.: 10/491,803

(22) PCT Filed: Sep. 26, 2002
(86) PCT No.: PCT/EP02/10825

(30) Foreign Application Priority Data
Oct. 5, 2001 (DE) 101 49 247.2

(51) Int. Cl. B60C 23/02

(52) U.S. Cl. 73/146.2

(57) ABSTRACT

The pressure in a motor vehicle tire can be determined by means of a ‘wheel-independent’ device (1) that is in a largely rigid manner connected mechanically to an element (2) of the vehicle body (3, 14) oscillating with the motor vehicle wheel (4).

In order to determine the—preferably absolute—tire pressure by combining the evaluation of rotational speed data and axle frequency analysis, said device (1) includes a signal pre-processing element (6) provided with electronic components for processing the sensor signals, said element being connected to a magnetic sensor element (7) and an acceleration sensor element (8) or to a combined magnetic/acceleration sensor element (5) by means of an electrically conductive element connection (9), wherein the magnetic sensor element (7) or the magnetic/acceleration sensor element (5) is operatively connected to a magnetic encoder (16) arranged on the wheel side.

To improve determination of characteristic quantities, preferably the vibration behavior of at least two wheels (4) is analyzed.

### BACKGROUND OF THE INVENTION

The present invention relates to a device for the combined detection of the axle acceleration and the wheel speed, wherein the device is mechanically connectable to an element of the motor vehicle chassis that resonates with one motor vehicle wheel respectively as well as a method of determining the pressure in a motor vehicle tire by means of a wheel-speed based method which assesses the tire pressure loss (DDS) by evaluating wheel speed data from several wheel speed sensors and producing quantities of the ratio between wheel speed data of different wheel pairs while taking into account data about the current driving condition.

Methods for monitoring the tire pressure or determining the tire pressure are known in the art, e.g. from DE-A-197 21 480, wherein a tire pressure loss can be calculated by evaluating a long-term running behavior of the individual motor vehicle wheels without the assistance of pressure sensors. Corresponding methods are used in motor vehicles e.g. under the name ‘DDS’ (Deflation Detection System). On account of the indirect measuring method, which is essentially based on the evaluation of wheel speed data, a DDS method is required to detect as reliably as possible disturbances affecting the tires' rotational speed caused by cornering, acceleration, slowing down, tire exchange, etc., and to correct the wheel speed data obtained in order to eliminate the effects of these quantities.

The quality of pressure loss detection depends, among others, on how precisely specific driving conditions can be detected. Already vibrations of the wheel axle have been detected and processed by acceleration sensors to improve pressure loss detection.

DE 38 09 886 discloses a wheel speed sensor comprising an acceleration sensor in addition to a wheel speed sensor. However, the sensor assemblies described are sophisticated in manufacture and need much mounting space.

Besides, high-quality wheel speed sensor modules in chip technology are required to precisely acquire wheel speed data, as described for example in German patent application P 44 45 120 or in DE-A-199 22 672. The described wheel speed sensor modules comprise a magnetized encoder rotating with the wheel and scanned by an active magnetic sensor element. The acquired wheel speed data is sent by way of a current interface to an integrated brake control unit that is appropriate for ABS, ESP, and the DDS described hereinabove.

On the other hand, there is the requirement of improving the driving performance and driving comfort by actively controlled wheel damper systems. Acceleration sensors in the area of the wheel axle are necessary for these actively controlled damper systems. An axle frequency analysis can be executed on the basis of the axle vibrations sensed by axle acceleration sensors of this type.

An object of the present invention is to determine the—preferably absolute—tire pressure by a combined evaluation of wheel speed information and axle frequency analysis. An integrated wheel module sensor unit shall be provided for this purpose, which combines acceleration sensors and wheel speed sensors to form a tuned total module.

This object is achieved by a device that includes a signal pre-processing element with electronic components for the pre-processing of sensor signals, which is connected to a magnetic sensor element and an acceleration sensor element or a combined magnetic/acceleration sensor element by means of electrically conductive element connections, and wherein the magnetic sensor element or the magnetic/acceleration sensor element is in operative engagement with a wheel-sided magnetic encoder, possibly in connection with a method that uses data about the vibration behavior of at least one of the wheels (4), being acquired by means of an acceleration sensor (8), with the aid of specific tire parameters for improving the determination of parameters.

The invention discloses a ‘wheel-independent’ tire pressure indication system on the basis of the rotational wheel-speed based ‘DDS’ known in the art.

The mere wheel speed data according to DDS permit indicating merely the pressure differences of the tire fill pressure of two wheels in each case.

The additional data necessary for an exact and absolute ‘wheel-independent’ tire pressure indication is obtained by means of an axle frequency analysis performed complementarily.

When the axle frequency analysis is performed only on one vehicle wheel, the input of specific tire parameters is necessary for a determination of the absolute pneumatic pressure.

When an axle frequency analysis is performed on at least two vehicle wheels, the parameters necessary for an absolute tire pressure determination can be established directly by means of the combined evaluation of DDS and axle frequency data.

That means: absolute tire pressure values are determined according to the present invention without the need for mounting battery-powered sensor modules into the wheels.

Because the range of relevant resonant tire frequencies is reasonably known, it is unnecessary to perform a complete Fourier analysis for the axle frequency analysis. It is fully sufficient to purposefully analyze only individual Fourier elements of the axle vibration. This will allow minimizing the calculating effort for the axle frequency analysis to a technically justifiable extent.

The determination of the tire properties by means of acceleration sensors on the wheel axle affords the advantage that only defined self-movements of the tire are transferred to the wheel axle. This filtering effect considerably simplifies the frequency analysis.

According to the invention, wheel speed sensor and acceleration sensor, preferably combined in a joint device, are coupled to the wheel axle in a mechanically stiff manner.

The method of the invention and the device of the invention can be used in motor vehicles, which also comprise commercial vehicles and passenger cars.

The device of the invention, among others, provides the advantage that a joint use of the interface and the necessary current supply in addition to low-cost manufacture is possible. Also, the reliability of the total system is enhanced by the integration into a joint housing sealed against environmental influences.

Further, the device of the invention can be used to realize an integrated control system within the integrated brake control unit, which performs the functions DDS, ABS, ESP, etc. performed already in a per se known fashion, in combination with a suspension control in a joint electronic control unit.

Further, advantages result with respect to a DDS method implemented because the additionally existing axle acceleration data can be used to improve DDS. The data of the DDS system and of the axle frequency analysis are not directly correlated. In addition, the functional dependencies of the DDS and axle frequency data of speed, wheel load, cornering, etc. are distinctly different. Thus, the related wider data range also leads to a higher rate of safety in the tire pressure control alarm in total. In principle, problematic driving conditions may thus be identified reliably, for example, for the rotational-speed based pressure loss detection, e.g. when tire wear prevails or when the motor vehicle is driven on extremely rough roads.

In a preferred embodiment of the invention, the per se known DDS method is extended in that the vibration behavior of the wheels is monitored and stored for a long period of time, and it is possible to reduce the required memory locations by data compression or data filtering.

### BRIEF DESCRIPTION OF THE DRAWINGS

In the drawings,

FIG. 1 shows an example for the installation of a device of the invention on a vibrating element.

FIG. 2 is a view of a device of the invention.

### DETAILED DESCRIPTION OF THE DRAWINGS

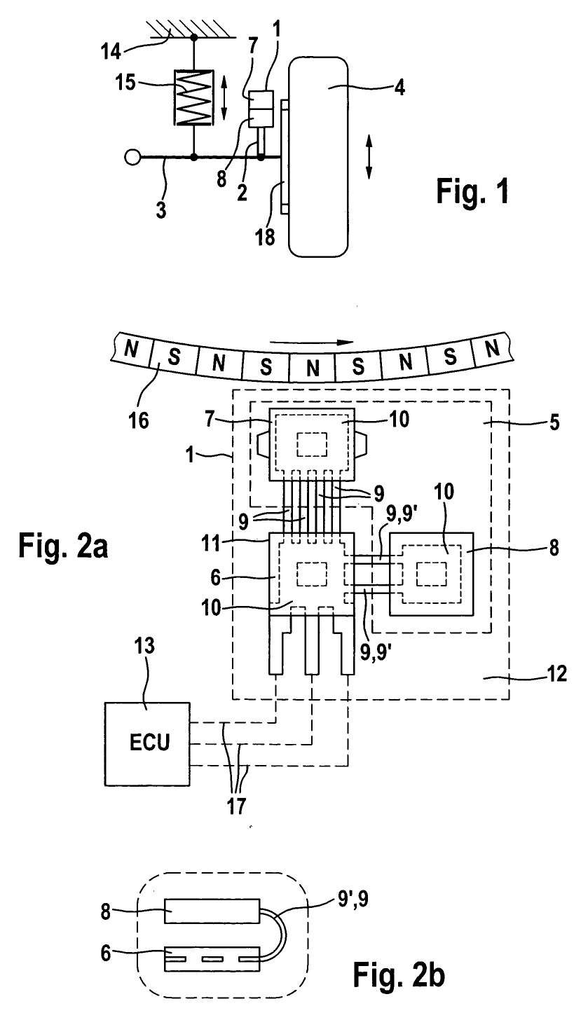

The embodiment of FIG. 1 schematically illustrates a wheel suspension 3 connected to the vehicle body 14 by way of a spring element 15, and a wheel 4 comprising tire, wheel rim and wheel bearing 18 is connected to said wheel suspension 3 in an oscillatory manner. A combination sensor 1 comprising a magnetic sensor element 7 and an acceleration sensor 8 is secured to the wheel suspension 3 in a mechanically stiff manner by way of a fastening element 2. As an acceleration sensor 8, e.g. per se known micro-mechanical sensors can be used which are etched into a silicon substrate, for example. When using micro-mechanical acceleration sensors, it is possible and preferred to integrate the acceleration sensor into the chip of the signal pre-processing unit. Reference numeral ‘16’ designates an encoder co-rotating with the wheel 4.

FIG. 2 is also a schematic view of a sensor assembly made up of a magnetized encoder 16 co-rotating with wheel 4 and magnetically coupled to the combination sensor element 1 through an air slot. Magnetic sensor element 7 detects the magnetic field of the encoder 16 by way of a magneto-resistive bridge circuit. The electric signals of the magnetic sensor element 7 are sent to an electronic conditioning circuit in a separately cased chip element 6. Similarly, electric signals of an acceleration sensor element 8 are additionally sent to the conditioning circuit. The sensor signals processed by the conditioning circuit are then sent to an electronic brake control unit (ECU) 13 by way of electric conduits 17. Normally, each motor vehicle wheel 4 is equipped with a sensor 1 according to FIG. 2a. The signal lines of the other sensor elements led to the control unit 13, are not shown. Preferably, the interface between sensor element 1 and ECU 13 is a current interface, with two or three wires, and the sensor signals are transmitted in coded form, preferably by means of pulse-shaped signals. Partial image b) depicts an embodiment in which the acceleration sensor 8, for the purpose of saving mounting space, is bent at the electric connection 9′ between the acceleration sensor element 8 and the signal conditioning element 6 for forming a sandwich-shaped block.

### LIST OF REFERENCE NUMERALS

1 combination sensor, sensor
2 fastening element
3 wheel suspension
4 wheel
5 combined magnetic/acceleration sensor
6 chip element, signal processing element
7 magnetic sensor element, wheel speed sensor
8 acceleration sensor, acceleration element
9,9′ electric connection (between 6 and 8)
10 lead frame
11 chip housing
12 embedding mass
13 brake control unit (ECU), control unit
14 vehicle body
15 spring element
16 (magnetic) encoder
17 electric conduits
18 wheel bearing

1-20. Canceled

21. A device (1) for the combined detection of the axle acceleration and the wheel speed, wherein the device (1) is mechanically connectable to an element (2) of the motor vehicle chassis (3, 14) that resonates with one motor vehicle wheel (4) respectively,
wherein the device comprises a signal pre-processing element (6) with electronic components for the pre-processing of sensor signals, which is connected to a magnetic sensor element (7) and an acceleration sensor element (8) or a combined magnetic/acceleration sensor element (5) by means of electrically conductive element connections (9), and wherein the magnetic sensor element (7) or the magnetic/acceleration sensor element (5) is in operative engagement with a wheel-sided magnetic encoder (16).

22. The device according to claim 21,
wherein the acceleration sensor element (8) is integrated in the housing of the signal pre-processing element (6).

2a. The device according to claim 22,
wherein an acceleration sensor element (8) is integrated on the same chip of the components for pre-processing element (6).

23. The device as claimed in claim 22,
wherein the signal pre-processing element (6), magnetic sensor element (7) and acceleration sensor element (8) are arranged in a chip housing (11), with said chip housing (11) being encompassed by a common embedding mass (12) for protection against circumferential influences.

24. The device as claimed in claim 21,
comprising connections (9) among its elements that constitute part of a common lead frame (10).

25. The device as claimed in claim 21,
wherein the acceleration sensor element (8) and the signal pre-processing element (6) are arranged in sandwich construction, and the element connections (9′) between the acceleration sensor element (8) and the signal pre-processing element (6) take a curved course.

26. A method of determining the pressure in a motor vehicle tire by means of a wheel-speed based method which assesses the tire pressure loss (DDS) by evaluating wheel speed data from several wheel speed sensors and producing quantities of the ratio between wheel speed data of different wheel pairs while taking into account data about the current driving condition,
wherein the method uses data about the vibration behavior of at least one of the wheels (4), being acquired by means of an acceleration sensor (8), with the aid of specific tire parameters for improving the determination of parameters.

27. The method according to claim 26,
wherein the method uses data about the vibration behavior of at least two wheels (4), wherein at least a part of the specific tire parameters required for determining absolute tire pressures and the type of tire are found out directly by a linked evaluation of data of a wheel-speed based pressure loss detection and of data from an axle frequency analysis.

28. The method as claimed in claim 7,
wherein wheels (4) of different axles are selected for the axle frequency analysis that is to be performed on at least two wheels (4), and the wheels (4) can have different dimensions.

29. The method as claimed in claim 26,
utilizing acceleration sensors (8) and wheel speed sensors (7) being configured configured as a device for the combined detection of axle acceleration and wheel speed.

30. The method as claimed in claim 26,
wherein the ratios of wheel radii are determined by the evaluation of wheel speed sensor signals.

31. The method as claimed in claim 26,
wherein the tire pressures are determined by the evaluation of wheel speed data of all wheel positions and the axle vibrations on at least two wheel positions.

32. The method as claimed in claim 26,
wherein a pre-selection is executed in the axle frequency analysis in such a fashion that axle vibration is suppressed and only the frequency range of a tire's natural vibration (pendulum oscillation) is filtered out of the respective spectra, being dependent on the type of pressure and tire.

33. The method as claimed in claim 26,
wherein the parameters are relative tire pressure values and the improved determination involves that relative tire pressure values are replaced by absolute tire pressure values which inhere a defined rate of uncertainty.

34. The method as claimed in claim 12,
wherein influences of wheel load and speed on the natural frequency of the pendulum oscillation are taken into account in calculations.

35. The method as claimed in claim 26,
wherein the tire pressure variations caused by changes in speed and different allotments of brake force and driving power are used to determine tire-related parameters.

36. The method as claimed in claim 26,
wherein a predefined pneumatic pressure for a tire is adjusted by means of a ‘reset button’ at the control unit.

37. The method as claimed in claim 26,
wherein an absolute tire pressure is determined for each individual wheel and indicated on a display device.

38. The method as claimed in claim 26,
wherein the method is executed in an integrated brake control unit (13) by a digital computing unit.

39. The method as claimed in claim 26,
wherein an exact value of the tire pressure is obtained by a statistic averaging operation of several wheel radii and axle frequency data.

40. The method as claimed in claim 26,
wherein the tire-related parameters are continuously corrected by adjustment of DDS and axle frequency analysis data, and operational changes of the tires.
